(19) United States
(12) Patent Application Publication
(10) Pub. No.: US 2014/0261331 A1
(43) Pub. Date: Sep. 18, 2014

(54) REFUELING SYSTEM FOR OUTDOOR POWER EQUIPMENT

(71) Applicant: BRIGGS & STRATTON CORPORATION, Wauwatosa, WI (US)

(72) Inventor: Jacob Schmalz, Milwaukee, WI (US)

(73) Assignee: BRIGGS & STRATTON CORPORATION, Wauwatosa, WI (US)

(21) Appl. No.: 13/830,903

(22) Filed: Mar. 14, 2013

(51) Int. Cl. F02M 37/00

(52) U.S. Cl. CPC F02M 37/0011
USPC 123/468

(57) ABSTRACT

A refueling system includes a filling station configured to store a first volume of liquid fuel, the filling station including a station receptacle, a removable fuel cartridge configured to store a second volume of liquid fuel less than the first volume of liquid fuel, and outdoor power equipment including an engine having an engine receptacle, wherein inserting the removable fuel cartridge into the station receptacle fluidly couples the filling station and the removable fuel cartridge to automatically fill the removable fuel cartridge with liquid fuel, and wherein inserting the removable fuel cartridge into the engine receptacle fluidly couples the removable fuel cartridge and the engine to provide liquid fuel to the engine.

### BACKGROUND

The present invention relates to the field of refueling systems for outdoor power equipment. Outdoor power equipment, including lawnmowers, snowthrowers, trimmers, tillers, pressure washers, etc., may be powered by an internal combustion engine running on a liquid fuel such as gasoline. Fuel for such engines is generally provided from a small, portable canister or other container, with the fuel being poured out of container into an opening in the fuel tank of the outdoor power equipment. Further, an open fuel container and/or open fuel tank can allow vaporized fuel to escape to atmosphere.

It would be advantageous to provide a system for refueling an engine for outdoor power equipment that minimizes the likelihood of spills and the release of vaporized fuel into the atmosphere.

### SUMMARY

One embodiment of the invention relates to an internal combustion engine including a pressure regulator including a first chamber with an inlet configured to receive a removable fuel cartridge and a second chamber fluidly coupled to the first chamber, and an air/fuel mixing device fluidly coupled to the pressure regulator, wherein the pressure regulator is configured to regulate the pressure of liquid fuel provided from the removable fuel cartridge to the air/fuel mixing device.

Another embodiment of the invention relates to outdoor power equipment including a removable fuel cartridge configured to store liquid fuel, a pressure regulator including a first chamber with an inlet that receives the removable fuel cartridge and a second chamber fluidly coupled to the first chamber, and an air/fuel mixing device fluidly coupled to the pressure regulator, wherein the pressure regulator is configured to regulate the pressure of liquid fuel provided from the removable fuel cartridge to the air/fuel mixing device.

Another embodiment of the invention relates to a refueling system including a filling station configured to store a first volume of liquid fuel, the filling station including a station receptacle, a removable fuel cartridge configured to store a second volume of liquid fuel less than the first volume of liquid fuel, and outdoor power equipment including an engine having an engine receptacle, wherein inserting the removable fuel cartridge into the station receptacle fluidly couples the filling station and the removable fuel cartridge to automatically fill the removable fuel cartridge with liquid fuel, and wherein inserting the removable fuel cartridge into the engine receptacle fluidly couples the removable fuel cartridge and the engine to provide liquid fuel to the engine.

Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, in which:

FIG. 1A is a perspective view of a fuel cartridge system with a fuel cartridge coupled to a filling station, in accordance with an exemplary embodiment.

FIG. 1B is a perspective view of the fuel cartridge system of FIG. 1 with the fuel cartridge coupled to a pressure regulator for an engine, in accordance with an exemplary embodiment.

FIGS. 2A-2C are sectional views of the fuel cartridge and the pressure regulator of FIG. 1B, taken along line 2-2.

FIG. 3 is a flowchart of a method for fueling an internal combustion engine, in accordance with an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring in general to the figures, a fueling system is shown in which the traditional fuel tank for an engine is replaced with a refillable cartridge system. The cartridge is affixed to the engine and can be refilled from a filling or docking station between uses. The connection port for the cartridge couples the cartridge to the engine and to the docking station with a quick connect, zero volume connection (e.g., a connection that results in no gap between the two pieces being coupled together). No gap between the pieces is evaluated with respect to the required tolerances for the two pieces establishing the zero volume connection. The cartridge can therefore be easily coupled to the engine or the filling station with no spillage of fuel.

Referring to FIGS. 1A-1B, a fueling system 10 for a piece of outdoor power equipment with an internal combustion engine 12 is shown according to an exemplary embodiment. The fueling system 10 includes a fuel cartridge 14 (e.g., canister, container, etc.) for containing a liquid fuel such as gasoline. The fuel cartridge 14 replaces a traditional fuel tank and provides fuel directly to the engine 12 to power the outdoor power equipment. After being emptied, the fuel cartridge 14 can be refilled from a filling station 16. In some embodiments, the fuel cartridge 14 has a capacity of approximately 1 liter. Because both the filling station 16 and the fuel cartridge 14 are sealed bodies, the venting of vaporized fuel can be reduced under certain circumstances.

According to an exemplary embodiment, the engine 12 is a small, gasoline-powered internal combustion engine. A broad range of engines may benefit from the teachings disclosed in this application. In some embodiments, the engine 12 may be vertically shafted, while in other embodiments, the engine 12 may be horizontally shafted. In some contemplated embodiments, the engine may include a single cylinder, two cylinders, or may include three or more cylinders. The engine 12 may have a four stroke cycle or may have a two-stroke cycle. According to an exemplary embodiment, the engine 12 is configured to power a walk behind lawn mower. In other embodiments, the engine 12 may be configured to power a broad range of outdoor power equipment, including riding lawn mowers, pressure washers, electric generators, snow throwers, trimmers, and other vehicles or handheld equipment.

Referring now to FIG. 2A, a schematic sectional view of the fuel input system of engine 12 is shown. According to an exemplary embodiment, the engine 12 includes an air/fuel mixing device 20. In various embodiments, the air/fuel mixing device 20 may be any suitable device, such as a carburetor or a fuel injector. Fuel is provided to the engine 12 from the fuel cartridge 14, which is removably coupled to a first chamber 23 including a first reservoir or chamber 23 and a second reservoir or chamber 25. The pressure regulator 22 receives a volume of fluid in the first chamber 23 at a pressure equal to the internal pressure of the fuel cartridge 14. The fuel is selectively allowed to pass from the first chamber 23 to the second chamber 25. The second chamber 25 stores the fuel at a desired pressure (e.g. atmospheric pressure) and delivers the fuel to the air/fuel mixing device 20 through a fuel line 26. In some embodiments, the second chamber 25 has an internal volume of approximately 200 mL and can have internal volumes of 1 L or greater.

The fuel cartridge 14 includes a container 30 with a neck 32 to which is coupled a connector 40 with a collar 42. The first chamber 23 has an inlet 28 that is configured to interface with the connector 40 and allow fuel to flow from the cartridge 14 into the first chamber 23. The collar 42 includes a cylindrical outer wall 43 and a cylindrical inner wall 44. The neck 32 of the container 30 is received in an annular space 45 between the outer wall 43 and the inner wall 44. A lip 34 on the neck 32 engages a first sealing member 36 (e.g., gasket, o-ring, etc.) to secure the collar 42 to the container 30 and seal the interface between the collar 42 and the container 30 to prevent the escape of liquid or vaporized fuel from the interior of the fuel cartridge 14. In some embodiments, the neck 32 is coupled to the connector 40 in different ways that omit the collar 42 (e.g., by welding the neck 32 to the connector 40).

According to an exemplary embodiment, the connector 40 includes an elongated cylindrical body fixed to the collar 42, The connector 40 is received in the inlet 28 of the pressure regulator 22. A sealing member 29 (e.g., gasket, o-ring, other appropriate sealing members, etc.) coupled to the distal end of the connector 40 engages the walls defining the inlet 28 to create a seal between the connector 40 and the pressure regulator 22. The relatively large depth of the connector 40 facilitates the alignment of the connector 40 within the inlet 28 and the proper coupling of the fuel cartridge 14 and the pressure regulator 22 when emptying fuel from the fuel cartridge 14. The fuel cartridge 14 is shown in FIG. 2B to be coupled to the pressure regulator 22 via a pinned coupling in which pin 31 secures connector 40 to the pressure regulator 22. In other embodiments, different methods of coupling the fuel cartridge 14 to the pressure regulator 22 are used, including a friction coupling between the connector 40 and the inlet 28 or a latch, clip, or other mechanical fastening device for coupling the fuel cartridge 14 to the pressure regulator 22.

Referring now to FIG. 2B, with the connector 40 inserted into the inlet 28, the fuel cartridge 14 may be pushed towards the pressure regulator 22. The connector 40 translates in the inlet 28 with the sealing member 29 sealing the interface between the connector 40 and the walls of the first chamber 23. In a first position, shown in FIG. 2B, a valve formed by a plunger 50 disposed in an open end 48 of the connector 40 is closed, preventing fuel from passing from the fuel cartridge 14 to the first chamber 23. A sealing member 51 (e.g., gasket, o-ring, other appropriate sealing members, etc.) is coupled to the plunger 50 to form a seal between the plunger 50 and the connector 40 when the plunger 50 is positioned in the open end 48 of the connector 40.

Pushing the fuel cartridge 14 toward the first chamber 23 causes the plunger 50 to contact a pin 54 disposed in the first chamber 23. The plunger 50 does not contact the pin 54 until the seal between the connector 40 and the pressure regulator 22 created by sealing member 29 is established. The plunger 50 is movable within an interior cavity 46 of the connector and is biased into the closed position shown in FIGS. 2B and 2C by a biasing member 55 (e.g., a coil spring) compressed between the plunger 50 and a base member 56.

As shown in FIG. 2C, the pin 54 moves the plunger 50 relative to the connector 40 out of the open end 48, creating a fluid path between the interior cavity 46 of the connector 40 and the first chamber 23 through an opening 58 in the plunger 50 and through the open end 48.

Gravity and the internal pressure of fuel in the fuel cartridge 14 force the fuel to pass from the fuel cartridge 14 into the first chamber 23. The fuel cartridge 14 may be pulled away from the first chamber 23 (e.g., when the fuel cartridge 14 is empty), reversing the above steps. As the connector 40 of the fuel cartridge 14 is pulled out of the inlet 28, the plunger 50 disengages the pin 54 and the plunger 50 is forced back into the open end 48 of the connector 40 by the biasing member 55 to close the open end 48. Further pulling the fuel cartridge 14 away from the pressure regulator 22 moves the sealing member 29 past the inlet 28, thereby breaking the seal, and then disengages the connector 40 from the pressure regulator 28. The fuel cartridge 14 and the interaction between the connector 40 and the inlet 28 minimize the likelihood that fuel will be spilled during the refueling of the engine 12.

The fuel enters the second chamber 25 through a valve 60 from the first chamber 23. The valve 60 has an opening 62 in a valve seat 64 that is selectively closed by a valve member 66. According to an exemplary embodiment, the valve member 66 is actuated with a float 70 disposed in the pressure regulator 22 via a linkage 72 in response to the amount of fuel in the second chamber 25. The opening 62 has a cross sectional area with an equivalent diameter large enough that air may vent from within the second chamber 25 to the first chamber 23 and the fuel cartridge 14 as fuel enters the second chamber 25, but small enough such that the force applied by the float 70 via the linkage 72 is sufficient to close the valve member 66 against the valve seat 64 when the second chamber 25 is full (i.e., when the float 70 is at a level or elevation indicating that the second chamber 25 is full).

The pressure in the interior of the fuel cartridge 14 and the first chamber 23 can be elevated above the pressure desired for fuel being supplied to the air/fuel mixing device 20. According to an exemplary embodiment, the fuel cartridge 14 and the first chamber 23 may have an interior pressure of up to 20 psi. The second chamber 25 has a vent 68 in the exterior wall and is at atmospheric pressure. While the vent 68 is shown as directly venting the interior of the second chamber 25 to atmosphere, in other embodiments, the engine 12 may further include a vapor filter (e.g., a carbon canister) or other device proximate to the vent such that the interior of the second chamber 25 is not in direct fluid communication with the atmosphere.

Fuel received through the valve 60 collects in the second chamber 25. The depth of the fuel in the second chamber 25 determines the position of the float 70 and the linkage 72. According to an exemplary embodiment, the linkage 72 is a four-bar linkage with a first link 74 pivotably coupled to a wall of the second chamber 25, a second link 76 pivotably coupled to the first link 74, and a third link 78 pivotably coupled to the second link 76 and a wall of the second chamber 25. The valve member 66 is fixed to the third link 78. The walls of the second chamber 25 act as the fourth link. The pivot point 75 between the first link 74 and the second link 76 contacts the upper surface or face 71 of the float 70. As fuel collects in the second chamber 25, the float rises, pushing upward on the pivot point 75 such that the angle 77 between the first link 74 and the second link 76 increases. The third link 78 is therefore pushed towards a vertical position closing the valve member 66 against the valve seat 64. The internal volume of the second chamber 25 and the geometry of the float 70 allows the valve 60 to be actuated via the linkage 72 if the engine 12 and the second chamber 25 are tilted. According to an exemplary embodiment the float 70 is able to close the valve 60 via the linkage 72 with the second chamber 25 tilted up to approximately 30° from horizontal (i.e., horizontal as shown in FIGS. 2A-2C). In other embodiments, the linkage 72 includes more or fewer than four links (e.g., a single link linkage that pivots about a single pivot point).

As the float 70 moves upward and the angle 77 approaches 180°, the force applied to the valve member 66 increases. When the float 70 is at its uppermost position, the valve 60 is closed and the angle 77 is at its maximum (e.g., 180°). According to an exemplary embodiment shown in FIGS. 2A-2C, the upper surface of the float 70 may be flat. According to another exemplary embodiment, the upper surface of the float 70 may form a depression (e.g., a conical depression) that prevents the first link 74 and the second link 76 from going over-center and the angle 77 from exceeding 180°. At the maximum angle 77, as determined by the geometry of the linkage 72, the linkage 72 applies a force to the valve member 66 that is greater than the pressure differential between the interior of the second chamber 25 (e.g. approximately atmospheric pressure) and the internal pressure of the fuel cartridge 14 and the first chamber 23, thereby closing the valve 60. This force applied by the linkage 72 at the maximum angle 77 may vary. For example, the float 70 reaches its uppermost position so the linkage 72 is at the maximum angle 77. As the pressure difference across the valve 60 changes (e.g., pressure differential between the first chamber 23 and the second chamber 25), the valve 60 opens adding more fuel to the second chamber 25. However, because the second chamber 25 already contained a volume of fuel sufficient to move the float 70 to its uppermost position, the added fuel does not cause the float 70 to rise above the uppermost position, but instead at least partially submerges the float. The float 70 still displaces this added fuel, thereby increasing the force exerted by the linkage 72 on the valve 60 and therefore requiring a greater pressure differential across the valve 60 to subsequently reopen the valve 60. According to an exemplary embodiment, the float 70 and the linkage 72 apply a maximum force equivalent to a force resulting from the canister pressure on the valve 60 and a safety factor (e.g., a canister pressure plus safety factor having a total value of approximately 25 psi).

The fuel passes from the second chamber 25 at a desired pressure through the fuel line 26 to the air/fuel mixing device 20. In the air/fuel mixing device 20, the fuel is vaporized and mixed with air before being provided to a combustion chamber of the internal combustion engine 12. Referring to FIG. 2A, as the fuel in the second chamber 25 is supplied to the air/fuel mixing device 20, fuel level in the second chamber 25 and the level of the float 70 on the surface of the fuel lowers. The first link 74 and second link 76 resting on the upper surface 71 also lower, which pivots the third link 78 and the valve member 66 away from the valve seat 64. With the valve 60 open, fuel can flow from the first chamber 23 to the second chamber 25 through the opening 62 until the fuel level in the second chamber 25 causes the float 70 to rise to its uppermost level and the linkage 72 closes the valve 60 as shown in FIGS. 2B-2C.

After the fuel in the fuel cartridge 14 has been exhausted, the empty fuel cartridge 14 may be removed by decoupling the connector 40, as described above. The empty fuel cartridge 14 may then be filled from a filling station 16 with an inlet configured to receive the connector 40. The filling station inlet is similar to the inlet 28. A single fuel cartridge 14 may be used to provide fuel to the internal combustion engine 12 or multiple fuel cartridges 14 may be used, with a full fuel cartridge 14 being coupled to the pressure regulator 22 while a second, empty fuel cartridge is refilled from the filling station 16. According to one exemplary embodiment, the outdoor power equipment may include storage for additional fuel cartridges 14 to increase the fuel capacity of the outdoor power equipment or provide storage for empty fuel cartridges. Although the interaction between the fuel cartridge 14 and the inlet 28 has been described with the inlet 28 opening upwards and the fuel cartridge 14 inserted and removed in a vertical direction, in other embodiments, different orientations (e.g., horizontal, angled, etc.) of the inlet 28 and the fuel cartridge 14 are used (e.g., the horizontal configuration of the filling station inlet shown in FIGS. 1A-1B).

Referring now to FIG. 3, a method 90 for refueling an internal combustion engine (e.g., engine 12) with a fuel cartridge system is shown according to an exemplary embodiment. An empty or partially empty fuel cartridge (e.g., fuel cartridge 14) is first coupled to a filling station (e.g., filling station 16) containing a fuel (step 92). The filling station may be provided locally, such as in a garage or other building at a residence where the outdoor power equipment powered by the internal combustion engine is utilized, or may be provided at a remote location, such as a gas station or other retail establishment. According to one exemplary embodiment, the filling station may be provided in a garage at a residence and may have a volume of approximately five gallons. Once coupled to the filling station, the fuel cartridge is filled with fuel from the filling station (step 94). According to an exemplary embodiment, the fuel cartridge is filled to less than full capacity (e.g., approximately 90% full), allowing room for expansion due to temperature variations. The fuel cartridge may have indicia to indicate to a user the preferred maximum level of fuel for the fuel cartridge. Once filled to a desired level, the filled fuel cartridge is removed from the filling station (step 96). According to an exemplary embodiment, the fuel cartridge is coupled to the filling station with a zero volume connection that opens automatically when the fuel cartridge is coupled to the filling station and closes automatically when the fuel cartridge is removed from the filling station. Fuel spillage when removing the fuel cartridge from the filling station is therefore minimized. In some embodiments, pre-filled fuel cartridges may be provided, such as at a gas station or other retail establishment. The pre-filled cartridges may include a seal or other tamper evident device covering the opening of the fuel cartridge. The filled fuel cartridge is the coupled to a receptacle (e.g., first chamber 23) coupled to the internal combustion engine (e.g., internal combustion engine 12) (step 98). If the cartridge includes a seal, the seal may be broken automatically when the fuel cartridge is coupled to the internal combustion engine. Once coupled to the receptacle, fuel is allowed to exit the fuel cartridge as controlled by the pressure regulator (e.g., valve 60) (step 100). The amount of the fuel provided to an air/fuel mixing device (e.g., air/fuel mixing device 20) may be regulated with a valve (e.g., valve 60) disposed along the path of the fuel between the fuel cartridge and the air/fuel mixing device (step 102).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The construction and arrangement of the elements of the internal combustion engine fueling system as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. Some like components have been described in the present disclosure using the same reference numerals in different figures. This should not be construed as an implication that these components are identical in all embodiments; various modifications may be made in various different embodiments. It should be noted that the elements and/or assemblies of the enclosure may be constructed from any of a wide variety of materials that provide sufficient strength or durability, in any of a wide variety of colors, textures, and combinations.

What is claimed is:

1. An internal combustion engine, comprising:
a pressure regulator comprising a first chamber with an inlet configured to receive a removable fuel cartridge and a second chamber fluidly coupled to the first chamber; and
an air/fuel mixing device fluidly coupled to the pressure regulator;
wherein the pressure regulator is configured to regulate the pressure of liquid fuel provided from the removable fuel cartridge to the air/fuel mixing device.

2. The engine of claim 1, wherein the pressure regulator further comprises a float configured to float on liquid fuel in the second chamber, and a valve disposed between the first chamber and the second chamber, wherein the valve is coupled to the float such that movement of the float causes movement of the valve;
wherein, with the float at an uppermost position, the valve is closed to prevent liquid fuel from entering the second chamber from the first chamber and, with the float below the uppermost position, the valve is open to allow liquid fuel to enter the second chamber from the first chamber.

3. The engine of claim 2, wherein the valve includes a valve seat having an opening sized to allow air and fuel to pass through the opening simultaneously when the valve is open.

4. The engine of claim 3, wherein the valve is coupled to the float with a linkage such that the force applied by the linkage and the float to the valve with the float at the uppermost position is sufficient to overcome the pressure difference across the opening and close the valve.

5. The engine of claim 4, wherein the linkage is a four bar linkage.

6. The engine of claim 1, wherein the pressure regulator further comprises a pin configured to open a fuel cartridge valve of the removable fuel cartridge when the removable fuel cartridge is coupled to the first chamber so that liquid fuel is allowed to flow from the removable fuel cartridge through the fuel cartridge valve to the first chamber.

7. The engine of claim 6, wherein, upon removal of the removable fuel cartridge from the first chamber, the pin allows the fuel cartridge valve to close, thereby preventing liquid fuel from exiting the removable fuel cartridge.

8. The engine of claim 6, wherein the pin engages the fuel cartridge valve after a seal is established between the pressure regulator and the removable fuel cartridge when coupling the removable fuel cartridge to the first chamber.

9. The engine of claim 8, wherein the pin disengages the fuel cartridge valve prior to the breaking of the seal between the pressure regulator and the removable fuel cartridge when removing the removable fuel cartridge from the first chamber.

10. Outdoor power equipment, comprising:
a removable fuel cartridge configured to store liquid fuel;
a pressure regulator comprising a first chamber with an inlet that receives the removable fuel cartridge and a second chamber fluidly coupled to the first chamber; and
an air/fuel mixing device fluidly coupled to the pressure regulator;
wherein the pressure regulator is configured to regulate the pressure of liquid fuel provided from the removable fuel cartridge to the air/fuel mixing device.

11. The outdoor power equipment of claim 10, wherein the pressure regulator further comprises a float configured to float on liquid fuel in the second chamber, and a valve disposed between the first chamber and the second chamber, wherein the valve is coupled to the float such that movement of the float causes movement of the valve;
wherein, with the float at an uppermost position, the valve is closed to prevent liquid fuel from entering the second chamber from the first chamber and, with the float below the uppermost position, the valve is open to allow liquid fuel to enter the second chamber from the first chamber.

12. The outdoor power equipment of claim 11, wherein the valve includes a valve seat having an opening sized to allow air and fuel to pass through the opening simultaneously when the valve is open.

13. The outdoor power equipment of claim 12, wherein the valve is coupled to the float with a linkage such that the force applied by the linkage and the float to the valve with the float at the uppermost position is sufficient to overcome the pressure difference across the opening and close the valve.

14. The outdoor power equipment of claim 10, wherein the removable fuel cartridge includes a fuel cartridge valve; and
wherein the pressure regulator further comprises a pin configured to open the fuel cartridge valve when the removable fuel cartridge is coupled to the first chamber so that liquid fuel is allowed to flow from the removable fuel cartridge through the fuel cartridge valve to the first chamber.

15. The outdoor power equipment of claim 14, wherein, upon removal of the removable fuel cartridge from the first chamber, the pin allows the fuel cartridge valve to close, thereby preventing liquid fuel from exiting the removable fuel cartridge.

16. The outdoor power equipment of claim 14, wherein the pin engages the fuel cartridge valve after a seal is established between the pressure regulator and the removable fuel cartridge when coupling the removable fuel cartridge to the first chamber.

17. The outdoor power equipment of claim 16, wherein the pin disengages the fuel cartridge valve prior to the breaking of the seal between the pressure regulator and the removable fuel cartridge when removing the removable fuel cartridge from the first chamber.

18. A refueling system, comprising:
a filling station configured to store a first volume of liquid fuel, the filling station including a station receptacle;
a removable fuel cartridge configured to store a second volume of liquid fuel less than the first volume of liquid fuel; and
outdoor power equipment including an engine having an engine receptacle;
wherein inserting the removable fuel cartridge into the station receptacle fluidly couples the filling station and the removable fuel cartridge to automatically fill the removable fuel cartridge with liquid fuel; and
wherein inserting the removable fuel cartridge into the engine receptacle fluidly couples the removable fuel cartridge and the engine to provide liquid fuel to the engine.

19. The refueling system of claim 18, wherein the engine includes a pressure regulator incorporating the engine receptacle to receive gasoline from the removable fuel cartridge, and an air/fuel mixing device fluidly coupled to the pressure regulator; and
wherein the pressure regulator is configured to regulate the pressure of liquid fuel provided from the removable fuel cartridge to the air/fuel mixing device

20. The refueling system of claim 19, wherein the pressure regulator further comprises an internal chamber for containing liquid fuel, a float configured to float on liquid fuel in the internal chamber, and a valve coupled to the float such that movement of the float causes movement of the valve;
wherein, with the float at an uppermost position, the valve is closed to prevent liquid fuel from entering the internal chamber and, with the float below the uppermost position, the valve is open to allow liquid fuel to enter the internal chamber.

21. The refueling system of claim 20, wherein the valve includes a valve seat having an opening sized to allow air and fuel to pass through the opening simultaneously when the valve is open.

22. The refueling system of claim 21, wherein the valve is coupled to the float with a linkage such that the force applied by the linkage and float with the float at the uppermost position is sufficient to overcome the pressure difference across the opening and close the valve.

23. The refueling system of claim 18, wherein a zero volume connection is established when the removable fuel cartridge is inserted into the station receptacle.

24. The refueling system of claim 18, wherein a zero volume connection is established when the removable fuel cartridge is inserted into the engine receptacle.
